(19) United States
(12) Patent Application Publication
(10) Pub. No.: US 2007/0082636 A1
(43) Pub. Date: Apr. 12, 2007

(54) Method and apparatus for searching, saving, and storing radio programs and broadcast frequencies and for the payments of music downloaded from a digital radio receiver

(76) Inventors: Gawins Mack, West Palm Beach, FL (US); R. Eugenia Mack, West Palm Beach, FL (US)

Correspondence Address: JOSEPH S. BECKMAN, 3104 SW WIMBELDON TERRACE, PALM CITY, FL, 34990, US

(21) Appl. No.: 11/248,746

(22) Filed: Oct. 12, 2005

(51) Int. Cl. H04B 1/18

(52) U.S. Cl. 455/186.1

(57) ABSTRACT

A novel method and apparatus for searching, saving and storing broadcast identification codes and broadcast frequencies for the improved delivery of radio content to listeners, and an automatic payment system that allows a digital radio receiver interface to utilize prepaid memory storage devices to provide payment for downloading music directly from the radio receiver.

### FIELD OF THE INVENTION

This invention relates to a novel method and apparatus for searching, saving and storing broadcast identification codes and broadcast frequencies for the improved delivery of radio content to listeners. This invention further relates to an automatic payment system that allows a digital radio receiver interface to utilize prepaid memory storage devices to provide payment for downloading music directly from the radio receiver.

### BACKGROUND OF THE INVENTION

Systems that provide embedded identification codes that describe the nature of broadcast works, such as the artist name, song, and/or CD title of the works are well known in the prior art. As a result, the prior art has evolved to where radio receivers have features that allow a listener to save and store the identification codes and then use the codes to search other radio channels for particular music selections. If the particular music selection is detected, the radio receiver may be switched to the radio channel that is currently playing the particular music selection. This function is disclosed in prior art U.S. Pat. No. 6,510,324 issued to Gawins A Mack, II and R. Eugenia Mack.

The prior art, however, does not save and store the broadcast frequencies or the identification codes of talk shows and their corresponding broadcast frequencies. An invention with the ability to save broadcast frequencies, in addition to identification codes, is more advantageous than the prior art because it enables a more efficient search function. This is particularly so where the broadcast frequency is associated with selected identification codes.

For example, radio stations typically play select genres of music and frequently replay the same songs on the stations' play lists. By saving and storing the broadcast frequencies, those frequencies that are more likely to be broadcasting the listener's preferred music or radio programs may be searched first before searching all other available broadcast frequencies. Thus, the listener is more likely to be alerted sooner when a particular music selection or radio program is playing than if the search function had to search all broadcast frequencies in a non-preferential order.

The prior art further does not contemplate capturing advertisements that are encoded with information pertaining to particular products or services. Clearly there is a need to allow listeners to capture this information, such as price, retail location, and Internet addresses, so that the listener may later view the information at a more convenient and safer time then while driving. Further, a need exists to allow the advertisement information to be saved to a removable memory device so that the user may later place the memory device into another device capable of accessing the Internet and directly connecting the user to the URL saved on the memory device to facilitate the purchase of the desired product or service quickly and conveniently.

The prior art further does not contemplate capturing broadcasted URL addresses for musical works, talk show programs, and radio frequencies on a memory device that is capable of accessing and transferring stored data to an internet media player; and prior art further does not contemplate capturing websites and webcasts based on transferred data.

Lastly, the prior art does not provide a means for allowing listeners' to prepay and download music directly from their radio receivers using removable, prepaid memory devices, such as memory sticks or cards. Radio receivers on the market today are capable of digitally recording and storing music from CDs on the radio receivers' hard drives, and are capable of playing memory devices, as disclosed in one such radio receiver, the Pioneer DEH-P90HDD CD/MP3/Memory Stick Player. However, the radio receivers are not capable of recording from the AM/FM tuner and can only playback the memory devices as opposed to recording directly to the devices. There are also portable adapters that allow MP3 players and other memory devices to be adapted and played through car radio receivers in particular. These devices, however, only provide a conduit to play pre-recorded material and do not provide a means for recording material. Lastly, there are now time-shifting devices on the market, such as Timetrax, which allows users to record XM and Sirius broadcasts and store the broadcasts on the users' personal computers to listen to at a later time. There are several disadvantages to this device, namely it can only be used with XM or Sirius satellite radio broadcasts, and it does not provide any payment means for recording the broadcasts. Many of these devices have already or likely will come under scrutiny from copyright owners because while they may have substantial non-infringing uses, they allow users to digitally record perfect copies of the material without paying for the material. Clearly there is a need for a device that allows users to record material directly from broadcasts and, at the same time, rightfully compensate the owners of the materials for such recordings.

The prior art does disclose payment distribution systems for various media. However, the prior art does not disclose the use of pre-paid memory devices for broadcast materials received by a radio receiver. For example, U.S. Pat. No. 6,714,797, issued to Heikki Rautila, discloses a system, method, and computer programs for ordering, paying for and downloading data to a mobile device. The Rautila patent is directed toward ordering from electronic shop server websites by accessing the Internet and is not directed toward recording radio broadcasts received by a radio receiver. Further, the Rautila patent only discloses payment through the use of a credit card or charging the user's mobile telephone account.

U.S. Pat. No. 6,434,535 issued to Michael S. Kupka, is a system for prepayment of electronic content using removable media and for the prevention of unauthorized copying. The system uses a media device that contains a credit amount for purchases. The system is directed to delivery of electronic content over secure transmission channels, namely the Internet, and networks with a server system during the payment and download process. The disadvantage to this system is that it must utilize a network system to process purchase credits, which would not be practical for mobile radio devices. Further, the invention is not directed to publicly available digital broadcast channels. Clearly there is a need for a mobile device that is capable of recognizing and processing purchase credits without having to connect to a network.

### SUMMARY OF THE INVENTION

The disclosed invention presents a number of advantages over the prior art. First, the invention allows users to capture and save broadcast frequencies, in addition to embedded identification codes, and then places those frequencies on a preferred list of frequencies that are searched for desired content before searching other frequencies. This feature will enable a more efficient search function to alert users of desired radio programs being broadcast on other channels. The invention will also allow users to capture and save the broadcast frequencies of radio talk shows as well as advertisements. The invention will be capable of saving advertisements without placing corresponding frequencies on the preferred frequencies list. Saving the advertisements without placing those broadcast frequencies on the preferred list will prevent searching frequencies from which advertisements originated. This will enhance the search function for preferred music by preventing unnecessary searching of advertisements.

All references files containing identification codes for music, talk show programs, and advertisements are stored on the receiver's hard drive or on a memory device, such as a memory stick or memory card. In addition to searching frequencies, the receiver will also search the embedded identification codes for pre-selected music and talk shows. When broadcasted identification codes compared to stored identification codes match, the receiver will immediately notify the listener with an audible alert when pre-selected content is on the air. The search feature will continuously search for pre-selected songs and radio programs in order to capture, and save the broadcast frequencies on the preferred list.

Another advantage of the present invention is that it will allow users to download music directly from digital radio broadcasts to removable, pre-paid memory devices, such as ordinary memory sticks and memory cards that can be readily obtained in the marketplace. In the preferred embodiment, the digital radio receiver interface includes at least one USB 2.0 port or slot for the removable, pre-paid memory device. The removable pre-paid memory device is capable of tracking and processing the purchase credits for music saved directly from the digital radio broadcasts. The pre-paid memory device is preferably created from the use of customized PGP software. To prevent misuse or theft, the pre-paid memory device utilizes digital rights management well known in the prior art.

A memory device may also be used to capture and save URL addresses and advertisement information. The memory device may then later be inserted into a device capable of accessing the Internet and directly connecting the user to the company's website as a result of the URL information being saved to the memory stick.

### BRIEF DESCRIPTION OF THE DRAWINGS

FIG. 1 is a flowchart illustrating a typical transaction from a broadcast.

FIG. 2 is a flowchart illustrating the radio receiver operation process.

FIG. 3 is a flowchart illustrating the non-radio operation process.

### DESCRIPTION OF THE INVENTION

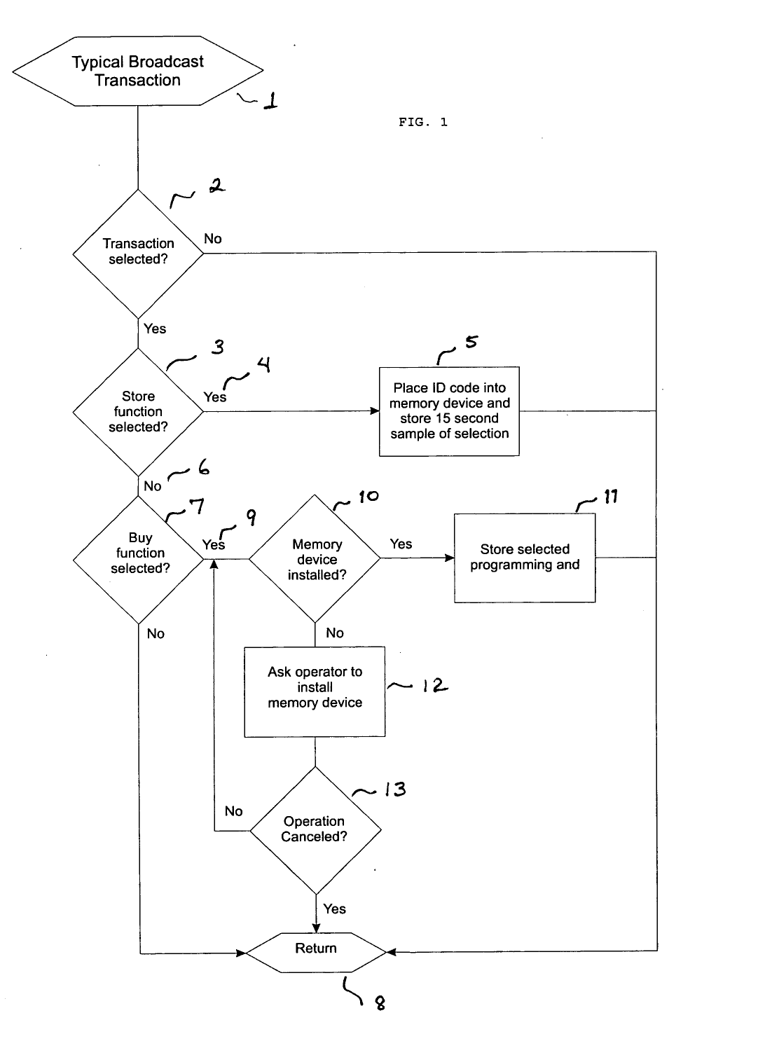

Referring now to FIG. 1, a typical transaction from a broadcast (1) is shown in accordance with the present invention. Once an operator selects a transaction (2), the radio receiver will determine whether the “store” function is selected (3). If store function is selected (4), the radio receiver will prompt the operator to place the IP code into the memory device and will store a 15 second sample of the selection (5). If the store function is not selected (6), the radio receiver will determine whether the buy function has been selected (7). If the buy function is not selected, the operator may select return (8) to end the transaction. If the buy function (7) is selected (9), the radio receiver will determine whether the memory device is installed (10). If the memory device is installed (10), the radio receiver will store the selected programming (11), and then the operator may select return (8) to end the transaction. If the memory device is not installed (10), the radio receiver will prompt the operator to install the memory device (12). If the operator does not install the memory device (12), the operation will be cancelled (13) and the operator may select return (8) to end the transaction. If a memory device is installed (12), the radio receiver will store the selected programming (11), and the operator may select return (8) to end the transaction.

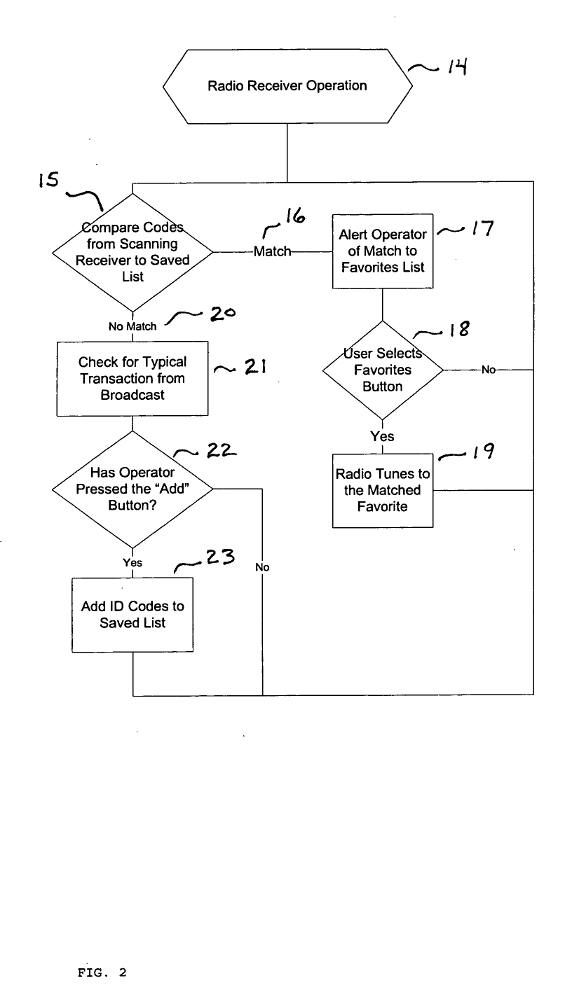

Shown in FIG. 2, is a flowchart illustrating the radio receiver operation (14) in accordance with the present invention. The operation begins with the radio receiver scanning the identification codes that are being broadcast and comparing those identification codes with the saved identification codes (15). If a match is found (16), an alert sounds to inform the operator that a match on the operator's saved list is currently being broadcast (17). The operator may select its favorites button (18) and by doing so the radio receiver will tune itself to the matched favorite being broadcast (19). Alternatively, if no match is found (20), then the radio receiver will check for a typical transaction from broadcast (21), as shown in FIG. 1. If a typical transaction from broadcast is detected, the radio receiver will go through the process illustrated in FIG. 1. The Operator may select the “add” button (22), which will add the identification codes to the saved list (23), and then when the process repeats itself, the recently saved identification codes (23) will be compared with the identification codes being broadcast (15).

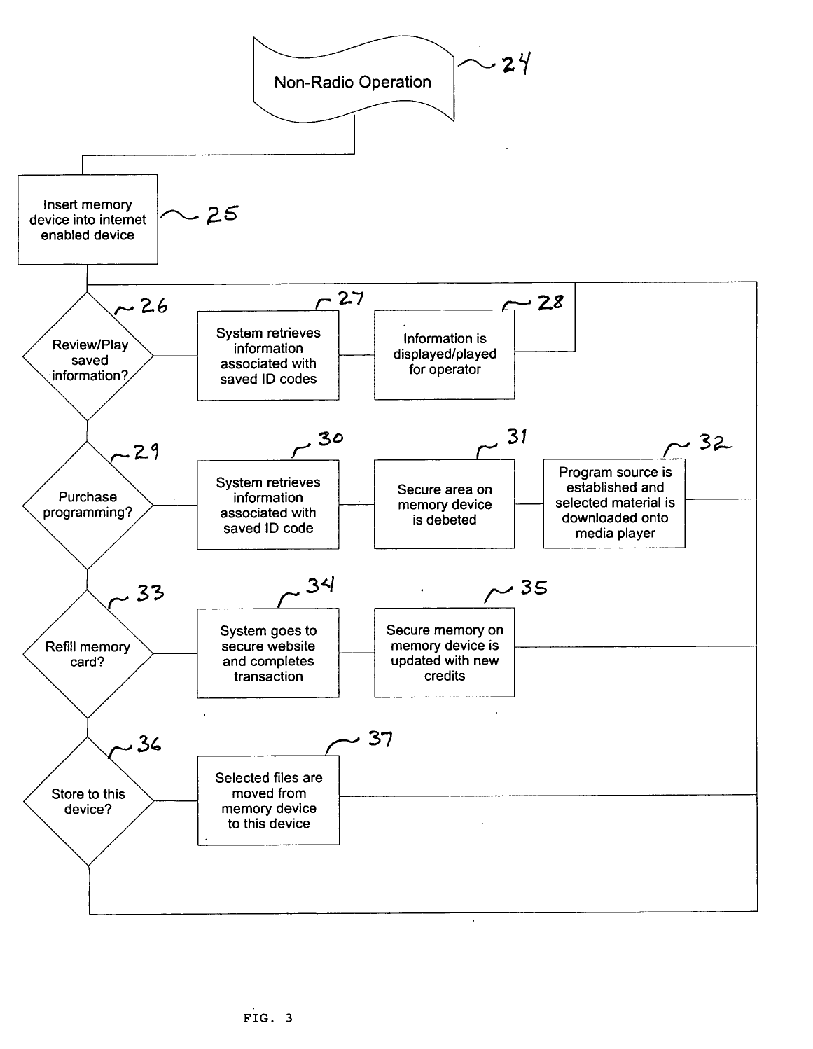

FIG. 3 illustrates another preferred embodiment wherein the embodiment does not require a radio receiver (24). An operator may insert a memory device into an Internet enabled device (25). Once the memory device is inserted, the operator may elect to review and play the information saved on the memory device (26). The system will retrieve the information associated with the saved identification codes (27) and the display or play the information for the operator (28). If the operator does not wish to review and play the saved information (26), the operator may elect to purchase programming (29). The system retrieves the information associated with the saved identification codes (30) and then debits the memory device from the devices secure area, which has been pre-paid (31). The program source is then established and the selected material is downloaded into the memory device (32). If the operator does not wish to review and play saved information or purchase programming, the operator also has the option of refilling his or her memory card (33). If the operator chooses to refill his or her memory card, the system will go to a secure website where the operator may complete the transaction (34). Once the transaction is complete, the secure memory on the memory device will be updated with new purchase credits (35), which the operator can use to purchase programming (29). Lastly, the operator has the option to store the files saved on the memory device to the Internet enabled device (36). If the operator chooses this option, the selected filed are moved from the memory device to the Internet enabled device (37).

What is claimed is:

1. A radio, said radio defined to include any device capable of receiving analog AM/FM, digital, and/or satellite broadcasts, and further comprising:
A radio receiver;
Means to receive broadcasted recording identification codes for music, talk shows and advertisements;
Means to capture and store identification codes for music and talk show radio programs;
Means to capture and store music identification codes and the associated radio broadcast frequencies;
Means to capture and store talk show program identification codes and the associated radio broadcast frequencies.

2. A radio as described in claim 1, further comprising a means to continuously monitor radio frequencies, and automatically capture and store frequencies when broadcasted identification codes compared to stored identification codes indicate a match.

3. A radio as described in claim 1, further including a means to monitor and compare music identification codes and talk show program identification codes stored in memory to music identification codes and talk show program identification codes on real time radio broadcasts;
means to display the radio frequency when broadcasted identification codes compared to stored identification codes indicates that a particular recorded work or program is broadcasting.
means to sound an alert and when broadcasted identification codes compared to stored identification codes indicates that a particular recorded work or program is broadcasting.

4. A radio as described in claim 1, further including a means to monitor and compare music identification codes and talk show program identification codes stored in memory to music identification codes and talk show program identification codes on real time radio broadcasts;
means to automatically tune the radio receiver to a frequency when broadcasted identification codes compared to stored identification codes indicates that a particular recorded work or program is broadcasting.

5. A radio as described in claim 1, further comprising a means to search stored frequencies for music identification codes and talk show program identification codes before searching non-stored frequencies.

6. A radio as described in claim 1, further comprising means to capture and store identification codes for advertisements.

7. A radio as described in claim 1, further comprising:
a means to capture and store broadcasted URL addresses for musical works, talk show programs, advertisements, and radio frequencies;
Means to capture and store the URL address and the associated identification code for a musical work;
Means to capture and store the URL address and associated identification code for talk show programs;
Means to capture and store the URL address and the associated identification code for advertisements; and
Means to capture and store URL addresses for corresponding digital and satellite broadcast frequencies and channels.

8. An internet media player, capable of receiving, digital, and satellite broadcasts, and further comprising;
Means to receive transmission of identification codes for music and talk show programs;
Means to capture and store music identification codes and the associated webcast; and
Means to capture and store talk show program identification codes and the associated webcast.

9. An internet media player as described in claim 8, further comprising;
Means to receive and store data via wireless transmission from memory storage devices and from digital and satellite receivers, including;
Identification codes for musical works, talk show programs, and advertisements;
URL addresses for musical works, talk show programs, advertisements, and radio frequencies;
Identification codes for musical works and the associated URL address;
Identification code for talk show programs and the associated URL address;
Identification codes for advertisements, and the associated URL address;
URL addresses for corresponding digital and satellite frequencies and channels.

10. A media player, as described in claim 8, further comprising means to continuously monitor and tag webcasts when broadcasted identification codes compared to stored identification codes indicate a match.

11. A media player as described in claim 8, further including a means to monitor and compare music identification codes and talk show program identification codes stored in memory to music identification codes and talk show program identification codes on real time webcasts;
means to display the webcast when broadcasted identification codes compared to stored identification codes indicates that a particular recorded work or program is broadcasting.
means to sound an alert and when broadcasted identification codes compared to stored identification codes indicates that a particular recorded work or program is broadcasting.

12. A media player as described in claim 8, further including a means to monitor and compare music identification codes and talk show program identification codes stored in memory to music identification codes and talk show program identification codes on real time webcasts;
means to automatically select a webcast channel when broadcasted identification codes compared to stored identification codes indicates that a particular recorded work or program is broadcasting.

13. A media player as described in claim 8, further comprising a means to search tagged webcasts for music identification codes and talk show program identification codes before searching untagged webcasts.

14. A radio, said radio defined to include any device capable of receiving analog AM/FM, digital, and/or satellite broadcasts, and further comprising:
A radio receiver,
Means to record music directly from digital and satellite radio receivers;
At least one means to accept a removable storage device,
Means to record music directly from the radio receiver to the memory device
A pre-paid memory storage device, said device including means to process and track purchase credits.

15. A radio as described in claim 14, wherein said pre-paid memory storage device further comprises an authorization code that may be keyed to the radio receiver's serial number and the media player's personal identification number.

16. A radio as described in claim 14 wherein said means to accept a removable storage device is a USB port.

17. A radio as described in claim 14 wherein said means to accept a removable storage device is a card slot.

18. A removable storage device as described in claim 14, wherein said method further comprises the step of using the memory device in a device capable of accessing the Internet, wherein the user may purchase download credits.

19. A method of processing and tracking purchase credits for payment of music downloaded directly from digital radio receivers wherein said method comprises the following steps:
Using a removable memory device containing means of storing purchase credits and using software to track downloads and debiting purchase credits.

20. A method as described in claim 19, wherein said method further comprises a communications memory device capable of wireless transmission of stored data, to and from digital radio receivers and the media player.
